(19) United States
(12) Patent Application Publication
(10) Pub. No.: US 2024/0302902 A1
(43) Pub. Date: Sep. 12, 2024

(54) LEVERAGING EYE GESTURES TO ENHANCE GAME EXPERIENCE

(71) Applicant: Sony Interactive Entertainment Inc., Tokyo (JP)

(72) Inventor: Brandon Sangston, San Mateo, CA (US)

(21) Appl. No.: 18/179,746

(22) Filed: Mar. 7, 2023

(51) Int. Cl. G06F 3/01; G06V 20/40

(52) U.S. Cl. CPC G06F 3/017; G06V 20/46

(57) ABSTRACT

Methods and system for providing assistance to a user during user's interaction with content includes tracking eye gestures of the user as the user is interacting with the content attributes associated with the eye gestures and to identify a first area within the content that the user is focusing on. An event that is predicted to occur requiring the attention of the user is detected in a second area. A visual cue is provided to assist the user by drawing their attention to the second area where the predicted event is about to occur within the content viewed by the user.

### FIELD

The present disclosure relates to systems and methods for capturing eye gestures of a user and using eye gesture data to provide assistance to the user while viewing content.

### BACKGROUND

With the growing amount of interactive content available online, users have the ability to search for and view interactive content that satisfies their search query. The user can use a wearable device to search for and view/interact with interactive content returned for the search query. As the user engages in the interactive content for an extended period of time, the user can experience eye fatigue. The eye fatigue can result in the user being unable to view the interactive content clearly as the content appears distorted or out-of-focus.

Additionally, as the display screens (i.e., monitors) used to render content increase in size, the users are able to view more and more content simultaneously. The content rendered on the display screen can be from a single interactive application (e.g., a streaming video game or streaming interactive content) or from a plurality of interactive applications. Content from the plurality of interactive applications are presented in distinct windows on the display screen. Due to the size of the display screen rendering content, either from a single application or from a plurality of applications, the user may be focused on content rendering in one portion of the display screen, the user may miss out on an action or an important event occurring in another portion of the display screen. For example, in the case where the display screen is being used to render game content of a video game, the user may be focusing on the game content that is rendering at a bottom right portion of the display screen while an event or action can be occurring or may be predicted to occur in top center or top left corner of the display screen. The bottom right portion of the screen may be rendering a game character of the user interacting with a game object while the game content rendering in the top center or top left corner of the display screen may show enemies or a monster sneaking up on the game character representing the user.

When the content rendered at the display screen is from a plurality of interactive applications, the content rendered in each distinct window can include game content of a video game, content of another interactive application other than the video game, chat content, social media content, email application or message content, podcast, picture/image/video content, etc. In order to assist the user to have a satisfactory content viewing experience, it is necessary to understand the different types of eye strains that the user can experience when interacting/viewing the content and provide appropriate hints or access to features to direct the attention of the user to the appropriate portion of the content.

It is in this context that embodiments of the invention arise.

### SUMMARY

Implementations of the present disclosure relate to systems and methods for capturing eye gestures of the user as the user is consuming interactive content rendered on a display screen associated with a wearable device used to view content, and providing appropriate assistance to the user so as to provide satisfactory content viewing experience for the user.

The system is configured to track the eye gestures of the user and to analyze the data related to the eye gestures to understand the various attributes of the eye gestures. Data related to the eye gestures are collected using various sensors disposed on the wearable device and within a physical environment where the user wearing the wearable device is present during interaction with the content. The attributes of the eye gestures can then be used to understand a type of eye strain experienced by the user. Based on the type of eye strain experienced, the system can be used to adjust certain features of the content so that the user is able to comfortably view and discern the content rendered at the display screen of the wearable device.

In addition to adjusting content, the system can also use the attributes of the eye gestures to determine the portion of the content the user is currently focused on, identify a portion of the content where an event is predicted to occur (i.e., portion of the content the user should be focusing on), and to provide visual indicators to direct the attention of the user to the portion of the content where the event is predicted to occur, when the portion of the content where the event is to occur is different from the portion of the content that the user is currently focused on. Providing visual indicators and/or auto-tuning a portion of the content allow the user to fully immerse in the content without fear of straining their eyes.

Tracking eye gestures using sensors include tracking data related to changes detected due to movement of the eyes and other facial features, such as eye gaze, eye position, eye shape, etc., facial gestures, head gestures, temporal attributes associated with the gestures, etc. The eye shape can be used to determine if the user is squinting, which can indicate that the user is having difficulty in deciphering the content presented at the display screen. Further, the eye shape can be used to understand the extent of user's squinting and the temporal attributes can further determine if the squinting was momentary or for an extended period of time. Similarly, eye gaze and eye position can be used to determine a direction of the user's gaze and correlate the gaze direction with a portion of the content rendering at the display screen. Tracking eye gestures involves a multi-level tracking that goes beyond capturing the gaze direction of the user by capturing eye shape, eye position, blink pattern, facial gestures, head gestures, etc., so as to provide a more thorough understanding of the user's comfort level when viewing and/or interacting with the content. Information related to the eye gestures captured by the various sensors are forwarded to the application providing the interactive content so that the application can use the information to provide visual hints or auto-tune the content so that the appropriate content is accessible and discernible to the user. The information related to the eye gestures can also be provided to the interactive application providing the content through an appropriate application programming interface (API). The application can use the eye gesture information to generate signal to dynamically auto-tune the content (e.g., magnify or reduce a size of the content, increase or decrease resolution of the content, highlight content) or, in the case of a video game content, activate a game character to guide the user within the game environment or provide a visual cue to direct the user's attention to a different portion of the content, or provide textual cue as overlays over the game content, etc.

In one implementation, a method for providing assistance to a user viewing content is disclosed. The method includes an eye gesture processing module that is configured to track eye gestures of the user viewing the content to identify attributes associated with the eye gestures. The attributes are used to determine a specific area of the content that the user is focusing on. The content is analyzed to determine an event that is predicted to occur in a second area of the content that requires the attention of the user, wherein the second area is different from the specific area that the user is focusing on. Responsive to detecting the event that is predicted to occur within the content, a visual cue is provided to direct attention of the user to the second area so as to assist the user to interact with appropriate portion of the content.

In an alternate implementation, a method for providing assistance to a user viewing content, is disclosed. The method includes an eye gesture processing module that is configured to track eye gestures of the user viewing the content. The eye gestures are analyzed to identify attributes associated with the eye gestures. The attributes are used to determine an area within the content that the user is focusing on. The attributes associated with the eye gestures of the user are analyzed to detect the user experiencing a type of eye strain that results in the user unable to discern the content. Responsive to detecting the type of eye strain, rendering attributes of a portion of the content presented in the area capturing the users attention is dynamically adjusted so as to make the content discernible to the user. A level of adjusting of the rendering attributes is defined based on vision characteristics of the user viewing the content.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

Various embodiments of the present disclosure are best understood by reference to the following description taken in conjunction with the accompanying drawings in which:

FIG. 1 represents a simplified block diagram of a system that includes a wearable device worn by a user as the user is interacting with content provided by a computer, in accordance with one implementation.

FIG. 2A illustrates a simplified block diagram identifying some of the components of a wearable device processor of a client device used for collecting and processing eye gestures of the user as the user is interacting with the content, in accordance with one implementation.

FIG. 2B illustrates a simplified block diagram identifying some of the components of a computer (e.g., local or remote server) for analyzing attributes of eye gestures to identify a type of assistance that needs to be provided to the user, in accordance with one implementation.

FIG. 3A illustrates a simplified block diagram of an eye gesture attributes identification engine of a client device used to identify eye gesture metrics, in accordance with one implementation.

FIG. 3B illustrates a simplified block diagram of an eye strain evaluation engine at a server computing device used to determine a type of eye strain experienced by the user and to dynamically auto tune content forwarded to the client device for rendering, in accordance with one implementation.

FIGS. 4A-1 and 4A-2 illustrate an example display region associated with a wearable device rendering content on which a visual cue is provided to assist the user in interacting with the rendered content, in accordance with one implementation.

FIGS. 4B-1 and 4B-2 illustrate another example display region associated with a wearable device rendering content on which a visual cue is provided to assist the user in interacting with the rendered content, in accordance with an alternate implementation.

FIG. 5A illustrates flow of operations of a method for providing assistance to a user during rendering of content, in accordance with one implementation.

FIG. 5B illustrates flow of operations of another method for providing assistance to the user for consuming content, in accordance with an alternate implementation.

FIG. 6A illustrates various sensors and visual indicators disposed on a wearable device that is used to collect eye gestures data of the user as the user is interacting with content, in accordance with one implementation.

FIG. 6B illustrates various components disposed within the wearable device that are used for requesting, receiving and rendering content and to collect various data captured of the user and the user's interaction with the content, in accordance with one implementation.

FIG. 7 illustrates components of an example system that can be used to process requests from a user, provide content and assistance to the user to perform aspects of the various implementations of the present disclosure.

### DETAILED DESCRIPTION

Systems and method for providing assistance to a user during viewing of content rendered at a client device are described. It should be noted that various implementations of the present disclosure are practiced without some or all of the specific details. In other instances, well known process operations have not been described in detail in order not to unnecessarily obscure various embodiments of the present disclosure.

The various implementations described herein allow an eye gesture processing module executing on a server of a computing system to capture and analyze facial features of the user as the user is interacting with content of an interactive application, and to trigger a signal to auto-tune content or provide visual cue to direct the user to a different portion of the content than the portion of the content that the user is focusing on. The facial features are used to determine if the user is experiencing eye strain that prevents the user from having a satisfactory viewing experience. Based on a type and level of eye strain experienced by the user, the auto-tuning signal is triggered to allow the user to view and interact with the content without undue hardship.

In addition to auto-tuning content, the system is also configured to provide assistance to the user during the user's interaction with the content of an interactive application. The assistance can be in the form of visual cues directing the attention of the user to an event or action occurring or predicted to occur in a different portion of the game. The visual cue, in some cases, can be accompanied with clues on how to interact with the event or action. For example, a user may have selected a video game for game play. During game play, the user may be engrossed in a portion of the content and may not be paying attention to other portions of the content. The other portions of the content may have an event or an action that is occurring or predicted to occur, such as a monster or some enemies approaching the user or a game object that is flying toward the user. As the user is focused on one portion and not paying attention to the other portions of the content, the user may not be prepared when the monster or the enemies launch a surprise attack on the game character representing the user, resulting in the user experiencing considerable loss in the video game (e.g., loss of one or more virtual lives or virtual assets). To assist the user in the game, the system tracks the eye gestures of the user by collecting data pertaining to the eye gestures from the different sensors/image capturing devices, and analyzing the collected data to determine which portion of the screen the user is focused on. The system also analyzes the game content to determine the content that is currently rendering in the portion of the screen that the user is focused on, content that is rendering in other portions of the screen, event or action that is likely to occur in the other portions, etc. Based on the analysis and determination, when the system determines that there is a likelihood of an event or action that is predicted to occur in another portion of the screen, the system provides a visual cue to inform the user that the event or action is likely to occur in the other portion. With the knowledge of the event or action that is likely to occur, the user can better prepare to respond to the event or action.

The multi-level tracking of the eye gestures of the user allows the system to distinctly determine where the user is looking or not looking, where the user should be looking, and provide cues to direct the attention of the user to the portion of the content where the user should be looking. The game logic may determine the location where the user should be looking by analyzing the game content, the current game state of the game and the input provided by the user. The analysis of the game content may identify a subsequent game state that is a natural progression from the current game state, and examining the subsequent game state in relation to the current game state to identify an event or an action that is predicted to occur and the location where the event or action is to occur. Based on this knowledge, the system provides signals to visually guide the user or adjust the content. In place of or in addition to visual hints, the system can also provide aural or haptic hints to guide the user to the event.

Tracking the eye gestures of the user provide more details that can be used to evaluate the physical condition of the user than what is provided by merely capturing the eye gaze of the user so that assistance can be tailored for the user. For example, the eye gestures captured by the various sensors are analyzed to identify various attributes, such as the user's eye shape, eye position, facial gestures, head gestures, blink pattern, blink rate, eye movement, direction of movement, speed of movement, etc., from which other attributes such as eye fatigue (determined from blink rate and/or eye shape), eye strain (including type and extent of eye strain-determined from eye shape when the user is squinting, for example), and other physical hardships experienced by the user can be easily deduced. The eye gaze, on the other hand, provides only directional aspect of the user's gaze. Based on the physical condition of the user as determined from evaluating the eye gestures, appropriate hints can be provided or appropriate portions of the screen can be highlighted to benefit the user as the user navigates through the content rendered on the screen.

With the general understanding of the disclosure, specific implementations of providing assistance to the user will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

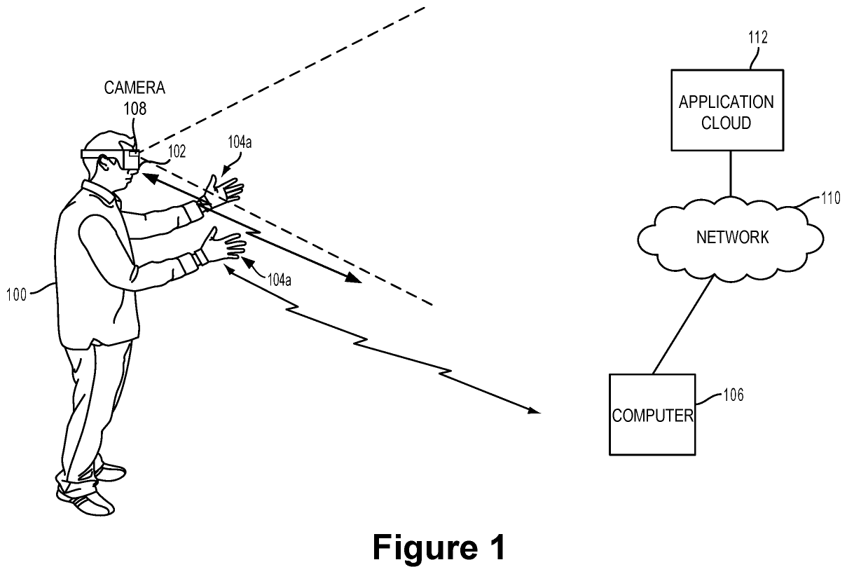

FIG. 1 illustrates a simplified block diagram of an example system in which a wearable device may be used to capture eye gestures of the user as the user is viewing or interacting with content rendered at a display screen of the wearable device and to use attributes of the eye gestures to provide assistance to the user, in one implementation. The system of FIG. 1 is can be used by the user for interacting with game content of a video game application. It should be noted that the system is not restricted to viewing or interacting with the game content but can also be extended to the user viewing or interacting with content of an augmented reality application or other types of interactive application. A user 100 is shown wearing a wearable device (e.g., head mounted display (HMD)) 102. The HMD 102 is worn in a manner similar to glasses, goggles, or a helmet, and is configured to render content from a video game or other interactive application on a display screen associated with the HMD 102 for the user 100 to view. In an alternate implementation, in place of the HMD 102, the user 100 may be wearing a pair of smart eyeglasses with a display screen used for rendering or providing interactions to content of an augmented reality application or other interactive application. In the case of the pair of eyeglasses, the content of the augmented reality or other interactive application may be provided on an external display screen associated with (i.e., communicatively connected to) the pair of eyeglasses. Considering the implementation where the wearable device worn by the user is the HMD 102, the HMD 102 provides a very immersive experience to the user by virtue of its provision of display mechanisms in close proximity to the user's eyes. The HMD 102 can provide display regions to each of the user's eyes which occupy large portions or even the entirety of the field of view of the user. Optics provided in the HMD 102 enable the user to view the content rendered in close proximity to the user's eyes. The optics takes into consideration the visual characteristics of the user when presenting the content to the user.

In one embodiment, the HMD 102 can be connected to a computer. The computer may be a local computer 106 or a server computer that is part of cloud 112 that is located remote to the HMD 102. As a result, the connection to computer may be wired or wireless. The computer (106/or part of cloud 112) can be any general or special purpose computer known in the art, including but not limited to, a gaming console, personal computer, laptop, tablet computer, mobile device, cellular phone, tablet, thin client, part of a set-top box, media streaming device, virtual computer, remote server computer, etc. With regards to remote server computer that is part of cloud 112, the server computer may be a cloud server within a data center of an application cloud system. The data center includes a plurality of servers that provide the necessary resources to host one or more interactive applications that provide the necessary content to the HMD 102 for rendering. The interactive application may be a distributed application that can be instantiated on one or more cloud servers within one data center or distributed across multiple data centers, and when instantiated on a plurality of cloud servers, the data of the interactive application is synchronized across the plurality of cloud servers. In one embodiment, the interactive application may be a video game application (i.e., virtual reality application) or an augmented/mixed reality (AR) application, and the computer is configured to execute an instance of the video game application or the AR application, and output the video and audio data from the video game application or the AR application for rendering on a display screen associated with the HMD 102. In another implementation, the server may be a stand-alone server 106 that is capable of executing an instance of the interactive application, or may be a server that is configured to manage one or more virtual machines that is capable of executing an instance of the interactive application (e.g., AR application or video game application) and provide the content for rendering, in real-time or delayed time.

Alternately, the server may include a plurality of consoles and an instance of the video game may be accessed from one or more consoles (e.g., game consoles). The consoles may be independent consoles or may be rack-mounted server or a blade server. The blade server, in turn, may include a plurality of server blades with each blade having required circuitry and resources for instantiating a single instance of the video game application, for example, to generate the game content data stream. Other types of cloud servers, including other forms of blade server may also be engaged for executing an instance of the interactive application (e.g., video game application) that generates the content of the interactive application (e.g., game content data stream).

The user 100 may operate a glove interface object 104a or a controller (not shown) or other input devices or input interfaces associated with the HMD 102 to provide input for the interactive application, such as the video game. Additionally, an image capturing device, such as a camera 108, can be configured to capture images of the interactive environment in which the user 100 is located. These captured images can be analyzed to determine the location and movements of the user 100, the HMD 102, the glove interface object 104a and/or the controller. In one embodiment, the glove interface object 104a or the controller includes a visual indicator, such as a light, which can be tracked to determine their respective location and orientation.

The controller can be a single-handed controller or a two-handed controllers. As noted, the controllers can be tracked by tracking lights associated with the controllers, or tracking shapes, and tracking inertial data provided by sensors associated with the controllers. Using these various types of controllers, or even simply hand gestures that are made and captured by one or more cameras, it is possible to interface, control, maneuver, interact with, and participate in the virtual reality environment presented on a display screen associated with the HMD 102.

Additionally, the HMD 102 may include one or more lights which can be tracked to determine the location and orientation of the HMD 102. In addition to the camera 108, one or more microphones are also included to capture sound from the interactive environment. Sound captured by the one or more microphones may be processed to identify the location of a sound source. Sound from an identified location can be selectively utilized or processed to the exclusion of other sounds not from the identified location. Furthermore, the camera 108 can be defined to include multiple image capturing devices (e.g. stereoscopic pair of cameras), an IR camera, a depth camera, or any two or more combinations thereof.

In another embodiment, the computer 106 functions as a thin client in communication over a network 110 with an application cloud 112 or a server computing device executing an interactive application or augmented reality application. In the case of the interactive application being a video game application selected for game play by the user 100, a server of the application cloud 112 maintains and executes an instance of the video game using the processor of the server or on a different server or instantiates the video game on the computer 106. In the case where the video game is executed on the application cloud 112, the computer 106 transmits inputs from the HMD 102, the glove interface object 104a and the camera 108, to the server on the application cloud 112, which processes the inputs to affect the game state of the executing video game. The output from the executing video game, such as video data, audio data, and haptic feedback data, is transmitted by the server of the application cloud 112 to the computer 106. The computer 106 may further process the data received from the server of the application cloud 112 before transmission or may directly transmit the data to the relevant devices for rendering. For example, video and audio data streams may be provided to the HMD 102, whereas haptic feedback data is provided to the glove interface object 104a and/or controller.

In one embodiment, the HMD 102, glove interface object 104a, and camera 108, may themselves be networked devices that independently and directly connect to the network 110 to communicate with the server at the application cloud 112. For example, the computer 106 may be a local network device, such as a router, that does not otherwise perform video game processing, but which facilitates passage of network traffic. The connections to the network by the HMD 102, glove interface object 104a, and camera 108 may be wired or wireless.

Additionally, the various implementations of the present disclosure described with reference to a head mounted display can be extended to other wearable devices or interactive devices, including without limitation, pair of eyeglasses, mobile devices (e.g., smart phones, tablet computing devices, etc.), or handheld devices (e.g., single-handed controller, double-handed controller, etc.). In the various implementations, the screen on which the content of the interactive application is being rendered for the user wearing the HMD to view may be a display screen of the HMD or an external display screen that is communicatively connected to the HMD 102. The external display screen may be a LCD display screen, a display screen associated with a portable computing device, such as a screen of a tablet computing device, screen of a mobile phone, etc., to which the HMD 102 is communicatively connected, or an external surface on which the content can be projected.

In one implementation, the HMD 102 includes a plurality of sensors that are used to capture changes in the facial features of the user as the user is interacting with the content presented at the display screen of the HMD 102. The changes in the facial features may be in response to the content being rendered on the HMD 102. The changes in the facial features captured by the sensors can be used to identify head gestures, facial gestures (changes to the shape of cheek, chin, mouth, nostrils, etc.), eye gestures, such as eye shape, eye position, eye gaze, direction, speed of movement, etc. In addition to capturing the changes to the user's facial features, temporal data associated with each of the changes are also captured by the sensors. Using the facial feature and the temporal data captured by the sensors, additional eye gestures, such as squinting of the eyes of the user, extent of squinting, etc., can be determined. The squinting of the eyes, extent of squinting, amount of time the user was squinting their eyes can indicate that the user is having a hard time deciphering content presented at the display screen. Some of the sensors used to capture the facial features include image capturing devices, inertial measurement unit (IMU) sensors, such as accelerometers, magnetometers, gyroscopes, etc. Image capturing devices include forward facing cameras disposed on the outer surface of the HMD 102, cameras disposed on the inside surface of the HMD 102 and directed toward the face of the user, external cameras facing the user and disposed in the physical environment in which the user wearing the HMD 102 is operating, depth cameras, etc. Data collected using these sensors can be used to track the location, orientation, direction, movement, speed of movement of the HMD 102 in the physical environment and therefore of the head of the user wearing the HMD 102, gaze direction, movement of the eyes, speed of movement, direction of eye movement, blink rate, eye shape, etc., of the eyes of the user, movement, direction, extent of movement, speed of movement, etc., of the different facial features of the user. The image capturing devices capture the finer details of the facial features and the eyes which can be analyzed and evaluated to determine various attributes associated with the facial features, such as facial gestures, head gestures, and eye gestures of the user.

The attributes identified from the changes in some of the facial features tracked using the various sensors are used to define additional attributes, such as eye squinting, expression of the user, physiological state of the user, etc., from which engagement metrics can be deduced. The attributes and the additional attributes obtained by analyzing data captured by the various sensors may then be forwarded by the processor of the HMD 102 to the computer 106, which can use the attributes and additional attributes to trigger an auto-tuning feature for adjusting selective portions of the content. Alternately or additionally, the attributes and the additional attributes are used along with details of an event that is predicted to occur within the content to provide visual cue to direct the user to a different portion of the content or different portion of the display screen where the predicted event is to occur.

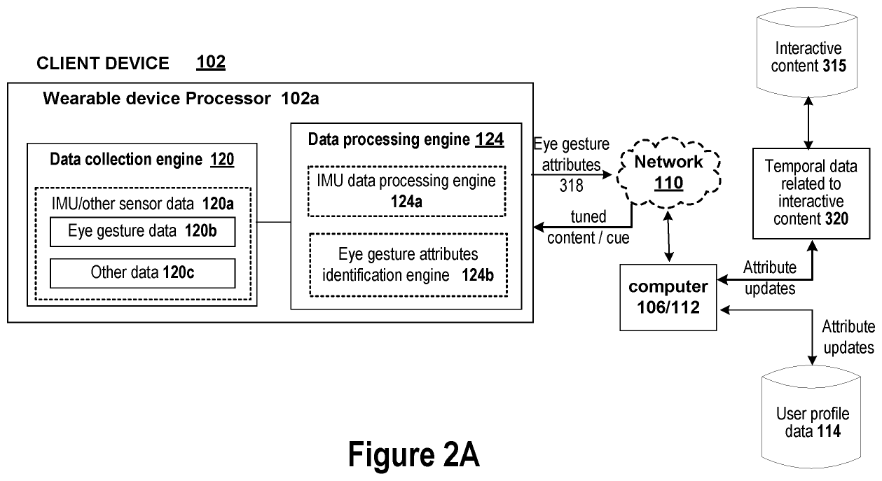

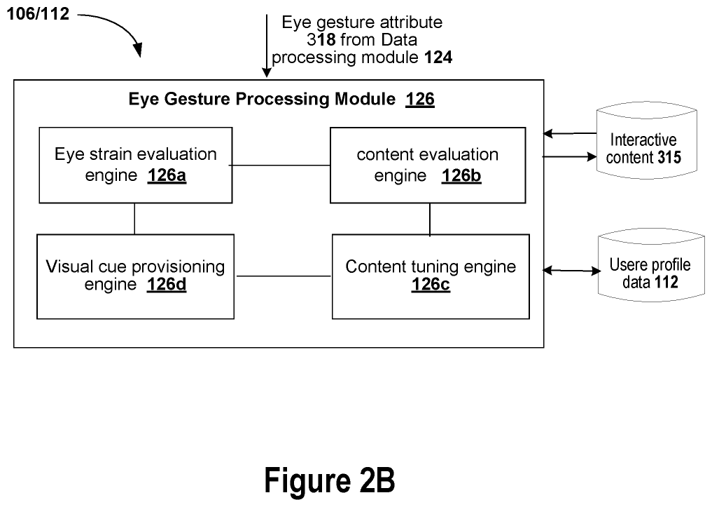

FIG. 2A illustrates some of the client-side components of a client device used to collect data related to the eye gestures and to process the collected data to identify various attributes associated with the eye gestures prior to forwarding the eye gesture attributes (318) to a computer for further processing. As an example, the client device is a wearable device, such as a HMD 102 as described above with reference to FIG. 1. The wearable device (e.g., HMD 102) is itself a computing device and includes memory (not shown) for storing data and a processor 102a for processing the data prior to forwarding to the display screen for rendering or to a computer 106 for additional processing. The data stored in memory and processed by the processor 102a can include IMU/other sensor data 120a collected from various sensors disposed within the physical environment in which the user is operating and from the sensors disposed on the wearable device. The data stored in memory can also include other data, such as rendering data, provided by external sources, such as content providers/content generators, for rendering on a display screen.

A data collection engine 120 within the processor 102a of the client device (e.g., HMD) 102 collects the sensor data captured by the various sensors disposed in and around the HMD 102 as the user is interacting with interactive content rendered on the display screen of the HMD 102, and performs a preliminary processing to identify the data types collected. For example, the data collected by the data collection engine 120 can include Inertial Measurement Unit (IMU) sensor data 120a collected from various IMU sensors and other sensors, such as image capturing devices (e.g., cameras, depth cameras, etc.). As noted above, the IMU sensor data 120a captured by the sensors include eye gestures data 120b, which includes facial gestures, head gestures and eye gestures, and other data 120c. The facial gestures data, for example, can include data related to movement of chin, cheeks, mouth, nose, eyebrows, forehead, including direction of movement, extent of movement of each of the facial features in each direction, temporal data associated with the movement in each direction, etc. The head gestures data can include data related to movement of the head, including direction of movement, extent of movement in each direction, temporal aspect associated with the head movement in each direction, etc. The other data 120c can include data related to movement of other wearable and user-controlled devices, such as smart gloves, controllers, etc., used to provide input during interaction with the content.

The data collected from the various sensors are provided as input by the data collection engine 120 to the data processing engine 124. The data processing engine 124 analyzes the data to identify the various attributes of the collected data. In some implementation, an IMU data processing engine 124a is engaged by the data processing engine 124 to analyze the data collected from the IMU sensors. The analysis is done to identify the specific facial features from which each respective gesture data was collected and the attributes of the gesture data captured by the sensors (IMU and other sensors). As noted above the collected data can pertain to eye gestures (i.e., eye gestures, head gestures, facial gestures) and other facial feature (e.g., cheeks, chin, nose, mouth, forehead, etc.) gestures. Once identified, the eye gesture data is processed by eye gesture attributes identification engine 124b to identify the specific facial feature pertaining to each gesture data collected and the attributes of eye gesture.

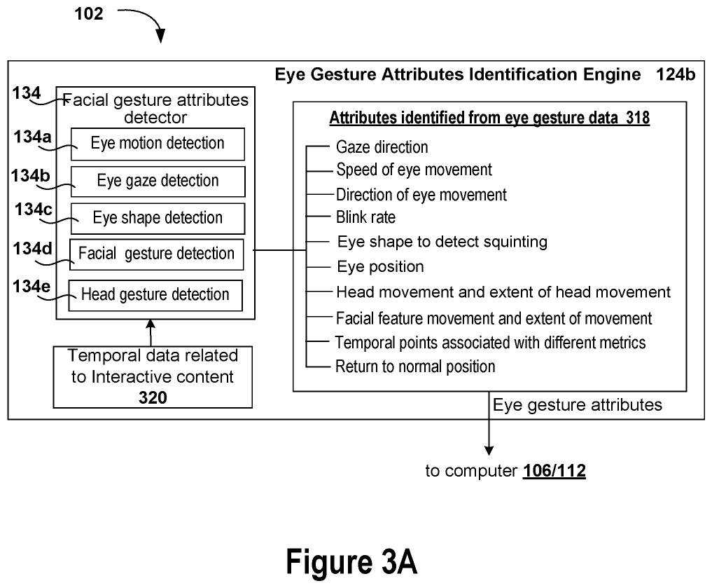

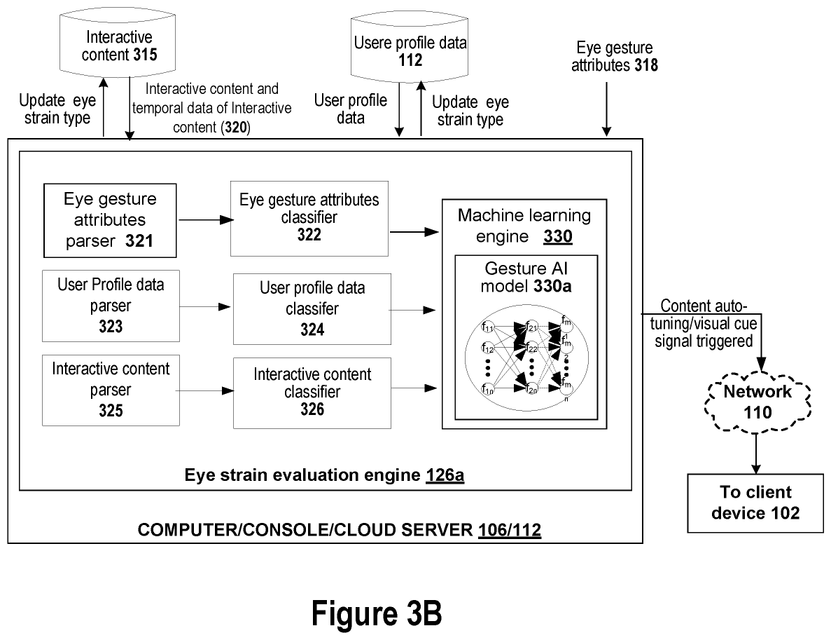

FIG. 3A illustrates some of the components within eye gesture attributes identification engine 124b of the client device (i.e., HMD 102) that are used to analyze the gesture data collected by the different sensors and to identify the different attributes of the collected gesture data. The eye gesture attributes so identified are then forwarded by the client device (e.g., HMD 102) directly or through the network 110 to the computer 106 for further processing. A facial gesture attributes detector 134 within the eye gesture attributes identification engine 124b is engaged to analyze the data captured by the different sensors and to identify each facial feature responsible for providing gesture data captured by the sensors and the different attributes of the gesture data. The facial gesture attributes detector 134 is used to detect, (a) eye motion using eye motion detection engine 134a, (b) eye gaze using eye gaze detection engine 134b, (c) eye shape using eye shape detection engine 134c, (d) facial gesture using facial gesture detection engine 134d, and (e) head gesture using head gesture detection engine 134e. The eye shape can be used to determine if the user is squinting, or is expressing frustration or anger or disappointment, indicating that the user is having a hard time viewing the content. For example, the facial gesture attributes detector 134 may use the eye shape, eye position, and eye gaze along with the interactive content and the temporal data related to the interactive content currently being rendered at the display screen to determine that the user is spending more time than normal staring at a particular portion of the screen leading to the user squinting. A level of squinting and amount of time the user spends squinting at a particular portion of the display screen are determined using the gesture data and the temporal data. The interactive content (e.g., game content) and the temporal data 320 are provided to the client device for rendering by an interactive application, such as the video game.

As noted above, some of the eye gesture attributes 318 identified from eye gesture data are listed on the right side of FIG. 3A. For example, the identified attributes can include gaze direction, eye movement, speed of eye movement, direction of movement, blink rate, eye shape (used to detect squinting), eye position, head movement, extent of head movement, other facial feature movement, extent of facial feature movement, temporal points associated with the different metrics, return to normal position, temporal point(s) when the eye is in normal position, to name a few. It is to be noted that the above list of attributes identified from eye gesture/facial feature data is provided as a mere example and fewer or additional attributes can be identified.

An eye gesture processing module (shown in FIG. 2B) engaged by the computer 106 uses the eye gesture attributes identified by the data processing engine 124 of the client device (e.g., HMD 102) to determine a type and extent of eye strain or eye fatigue experienced by the user. Based on the type of eye strain or eye fatigue experienced by the user and determined from the collected eye gesture data, the eye gesture processing module can auto-tune portion of the content rendering on the screen associated with the HMD 102 so that the content can be discernible to the user. In some implementations, the auto-tuning includes magnifying or reducing textual portion of the content or zooming-in/zooming-out image content. Additionally, based on where the user is looking and where the user should be looking, the eye gesture processing module can provide additional content or hints or cues or other accessibility feature to direct the user's attention to the area where the user should be looking.

The attributes of the eye gestures are updated to the user profile of the user stored in user profile database 114. The attributes of the eye gestures are also updated to appropriate portion of interactive content stored in the interactive content database 315 using temporal data related to the interactive content. As the content changes, attributes identified for the collected eye gestures of the user also changes based on the changes detected in the content. Consequently, the user may experience eye fatigue when viewing certain portion of the content due to amount of content rendering in the portion or the speed at which the content is being rendered, while the user may not experience any eye fatigue when viewing other portions of the content.

Referring now to FIG. 2B, FIG. 2B illustrates some of the server-side components of a computer used to process the eye gesture attributes identified by the data processing engine 124 of the client device (e.g., HMD) 102 in order to provide assistance to the user during interaction with the content, in one implementation. The computer, as noted previously, can be located locally or remotely from the client device. Depending on the location of the server computer, the eye gesture attributes are forwarded to the server computer directly or over the network 110, for further processing. The server includes a server-side eye gesture processing module 126 to evaluate the eye gesture attributes and to identify a type of assistance that needs to be provided to the user, and to generate appropriate signals to either adjust the content or provide the needed assistance to the user during viewing of the content. To evaluate the attributes and provide the needed assistance, the eye gesture processing module 126 includes an eye strain evaluation engine 126a, a content evaluation engine 126b, a content tuning engine 126c, and a visual cue provisioning engine 126d.

The eye strain evaluation engine 126a is engaged to examine and evaluate the attributes of the eye gestures received from the client-device 106/or part of a cloud 112 and to determine any eye strain/fatigue and the extent of the eye strain/fatigue experienced by the user as the user is interacting with the content rendered at the client device. The various sensors at the client device 102 monitor the facial features of the user while the user is interacting with the content to capture the changes in the facial features and register the changes. The changes in the facial features, for example, are captured by tracking the movement and extent of movements of the eye lids, eye lashes, nose, mouth, cheeks, chin, eyebrows, forehead, etc., head movement, etc. Data pertaining to these changes are forwarded to the server-side eye gesture processing module 126 as facial feature attributes. The eye gesture processing module 126 evaluates the facial feature attributes to identify the subtle signs of eye strain/eye fatigue experienced by the user. In some implementations, the evaluation of the facial features is performed by a machine learning engine. The machine learning engine takes into consideration the various attributes of the eye gestures and identifies an output that indicates if the user is experiencing eye strain/fatigue and the extent of the eye strain/fatigue.

FIG. 3B illustrates a machine learning engine 330 engaged by the eye strain evaluation engine 126a to determine if the user is experiencing any eye strain/fatigue and whether the system needs to perform auto-tuning or not. The eye gesture evaluation engine 126a includes parsers and classifiers to parse and classify the various data that is to be considered for determining if the user requires assistance during interaction with the interactive content. The classifier information identified by the data classifiers is forwarded along with the data to the machine learning engine 330 to build and train a gesture artificial intelligence (AI) model 330a. Output from the trained gesture AI model 330a is used to determine if the user is experiencing eye strain and, if so, a type of eye strain and a level of the eye strain experienced by the user when interacting with the content. The output from the trained gesture AI model 330a is used by the eye gesture evaluation engine 126a to determine if assistance needs to be provided and the type of assistance to be provided to the user.

The various data provided to the machine learning engine 330 as input includes eye gesture attributes 318 identified from the sensor data collected by the various sensors at the client device (e.g., HMD) 102, interactive content data provided by the interactive application and stored in the interactive content database 315, and user profile data maintained for each user in the user profile database 114. The interactive content data includes both the interactive content and temporal data 320 associated with the interactive content so as to identify time associated with each frame of content of the interactive application forwarded to the client device for rendering. The interactive content and the timeline information can be used to determine the type of content (e.g., content that is rendered at high speed, dense content, textual content that is hard to see or read, etc.) that is currently being rendered, the times when each specific type of content is being rendered, eye gesture attributes currently detected and previously recorded for the user and for the other users, etc. The temporal data with the interactive content can be used to correlate the type of content to the type of eye gestures expressed by the user when viewing/interacting with the content. Similarly, the user profile data is specific to each user and includes user related data including user identification information, user preferences and user customizations specified by the user.

The eye gesture attributes 318 received from the client device 102 are parsed using eye gesture attributes parser 321 to identify the different types of attributes and classify the different types using eye gesture attributes classifier 322. The classification tags the attributes with metadata to enable identification of the different types of attributes identified by monitoring the eye gestures of the user during the user's interaction with the content and to identify types of eye strain experienced by the user. The classifier data of the eye gesture attributes is provided to the machine learning engine 330 as an input.

Similarly, user profile data of the user retrieved from the user profile data 114 is parsed using user profile data parser 323 to identify the type of profile data and to classify the profile data based on the type. The user profile data can be used to identify normal eye attributes, such as normal eye shape, normal eye position, normal blink rate, etc. The normal eye attributes can be used to compare against eye gesture attributes captured during interaction with the content to determine if the eye gestures of the user captured during the user's interaction with the content show eye strain or eye fatigue. Similarly, the eye gesture attributes of the user are compared against the corresponding eye gesture attributes of other users when they were interacting with the corresponding portion of the content. The classified user profile data is also provided to the machine learning engine 330 as input.

The interactive content rendered at the client device along with the temporal data related to the interactive content are parsed using an interactive content parser 325 of the eye strain evaluation engine 126a to identify a type of interactive content rendering at the client device at different times and to classify the interactive content in accordance to the content type. The classifier data of the interactive content is provided to the machine learning engine 330 as an input. The type of content that is rendered at different times can affect the user's eye gestures. As noted before, the content provided to the user can be from a streaming game. In some cases, the game itself may be a high speed game or certain portions of the content of the game may be rendered at high speed or may include dense game content. As a result, the user may have to strain their eyes to absorb all the details included therein to ensure that they provide appropriate inputs in a timely manner to progress in the game. As the content is changing fast (due to the speed of change in the content) or includes a lot of game data (due to density of content), the user may have to strain their eyes to keep on top of the changes to the content or amount of data so that they can provide the appropriate input. The interactive content rendered at different times is taken into consideration so that the type of content can be correlated with the different eye gestures captured during the user's interaction with the content.

The classifier data from the eye gesture attributes classifier 322, user profile data classifier 324 and interactive content classifier 326 are used by the machine learning engine 330 to create and train a gesture AI model 330a. The gesture AI model 330a uses the classifier data to generate an output that identifies the type of eye strain experienced by the user, based on the eye gesture data, interactive content and the user profile data of the user. The output from the AI model is evaluated by the eye strain evaluation engine 126a to determine the type of eye strain and extent of eye strain of the user. Based on the type and level of eye strain, the eye strain evaluation engine 126a generates a signal to auto-tune the content, in some implementations. In some implementations, the auto-tuning includes dynamically adjusting the portion of the content in the direction of the user's eye gaze by magnifying or reducing a size of the content rendered in the portion. In some implementations, the amount (i.e., a level) of magnification or reduction can be specific for the user and can depend on the visual characteristics of the user. In alternate implementations, the type of content and the eye gesture attributes can be used to generate a signal to highlight a specific portion of the content to direct the user's attention from a portion that aligns with the user's gaze to the specific portion that is away from the user's gaze. The specific portion may be identified to include an action or an event that is predicted to occur based on the input provided by the user, wherein the prediction is based on the content that is currently rendering and the game state of the game, for example.

Referring back to FIG. 2B, the type of eye strain experienced by the user as obtained from the gesture AI model 330a is provided to a content evaluation engine 126b. The content evaluation engine 126b evaluates the content and the type of content currently rendering that corresponds with the type of eye strain experienced by the user and identifies the type of adjustment that needs to be made to the portion of the content so as to reduce the eye strain or eye fatigue of the user. The specific portion and the type of auto-tuning that needs to be provided to the specific portion are identified and forwarded by the content evaluation engine 126b to the content tuning engine 126c. The content tuning engine 126c uses the details provided by the content evaluation engine 126b to generate appropriate signals to the interactive application to dynamically tune the portion of the content. The dynamic tuning can be to magnify the images or textual content included in the portion of the content. Alternately, the dynamic tuning can be to enhance the resolution of the images or textual content or highlight the images or textual content. The magnified images or textual content are then provided as overlays for rendering over the portion of the content.

In alternate implementations, the content evaluation engine 126b may provide details of the portion of the content that the user is focused on and the portion of the content the user needs to focus on. The portion of the content that the user is focused on and needs to focus on can be identified by evaluating the current state of the interactive application, such as the video game. The portion of the content that the user is currently focused on, in some implementations, is rendered using foveated rendering format, wherein the portion that is in line with the user's gaze direction (i.e., portion that the user is focused on) is rendered at the highest resolution and the surrounding portions are rendered at a much lower resolution than the portion that is in line with the user's focus.

The identification of the appropriate portions (focused portion and need-to-focus portion) of the content are provided to a visual cue provisioning engine 126d. The visual cue provisioning engine 126d uses the identified portions to generate appropriate signals to adjust the rendering attributes of the identified portions, in some implementations. For example, in some implementations, the visual cue provisioning engine 126d generates a first signal to adjust the rendering attributes of the first portion of the content that the user is focused so as to reduce the resolution and a second signal to adjust the rendering attributes of a second portion of the content that the user needs to focus on so as to enhance the resolution (e.g., render at highest resolution). The adjusting of the resolution causes the first portion to be de-emphasized and the second portion to be emphasized (i.e., highlighted). In alternate implementations, the first signal may be generated to magnify a size of the content included in the second portion and the second signal may be generated to reduce the size of the content included in the first portion. The various components of the eye gesture processing module 126 identifies the portions that the user is looking or not looking and what the game for that portion determines (based on the current game state) the user should be looking at, and provides content or additional hints or accessibility type features to enable the user to access, view and interact with the content without straining their eyes.

In the implementations illustrated in FIGS. 2A and 2B, the data collection engine 120 and data processing engine 124 at client-side and the eye gesture processing module 126 at the server-side can be software modules that are executed by the respective processors. In some implementations, the software modules at the client-side and/or the server-side can be part of the respective operating system so that the assistance provided to the user can be provided for any content irrespective of the application providing the content, and without requiring each application to be updated to incorporate the components required for providing assistance to the user. In alternate implementations, the data collection engine 120 and data processing engine 124 at client-side and the eye gesture processing module 126 of the server-side can be built into the respective hardware. The hardware components can assist in highlighting or providing visual indicators as overlays over the content rendering at the client device, irrespective of which interactive application is providing the content. In alternate implementations, the attributes of the eye gestures identified by the data processing engine 124 at the client device can be provided to the interactive application executing at the computer (e.g., server computing device located remotely, such as cloud server) via an application programming interface (API). The attributes of the eye gesture can be provided to the eye gesture processing module 126 executing at the server computer, which processes the eye gesture attributes and forwards to the application providing the content so that the application can use the eye gesture attributes to assist the user in ways that it deems appropriate. For example, when the interactive application providing the content to the user is a video game, the video game application can determine the portion of the content the user is focusing on, the portion of the content that the user should focus on, and generates a signal to activate a game character within the video game to guide the user to a different location of the game scene. Alternately, the application can initiate a signal to highlight or enhance resolution of a portion of the content that the user is focused on to enable the user to view the content clearly.

In some implementations, the enhancement in the resolution of the portion of the content can be in the form of foveated rendering of the portion of the content, wherein the content in the portion is brought into focus by enhancing the resolution while the other content outside of the portion is rendered with reduced resolution. The foveated rendering is especially useful when content provided to the user is streaming content (e.g., streaming game content from a live game play of a video game) and the foveated rendering enables the system to highlight a specific portion of the content where action or event is predicted to occur so as to direct the user's attention to the event/action. The foveated rendering enables the system, in substantial real-time and in a non-obtrusive way, to draw attention of the user to a virtual focus spot within the content that is different from the location that is capturing the user's interest. The foveated rendering, for example, leverages on what is already happening and what is predicted to happen within the content, based on the current game state of the user and the input provided by the user.

For example, if the eye gesture processing module detects eye-strain in the user, based on the collected attributes, the eye gesture processing module uses the attributes identified from the eye gestures of the user, compares the observed attributes of the user with previous attributes of the user or attributes of the other users who viewed the same content previously, and auto-tunes the content in accordance to the observed attributes and visual characteristics of the user so that the tuned content can be easily viewed and discerned by the user. The auto tuned content is then forwarded to the client device for rendering. Alternately, visual cues may be provided to the user to direct the user's attention to an event or action that is predicted to occur in a different area of the screen than the area where the user's focus is directed. In some implementations, the visual cue can be provided in the form of foveated rendering, wherein a portion of the content that needs to be brought to the attention of the user is brought into focus by enhancing resolution while the remaining portions of the content are rendered at a resolution that is lower than the portion that is brought into focus.

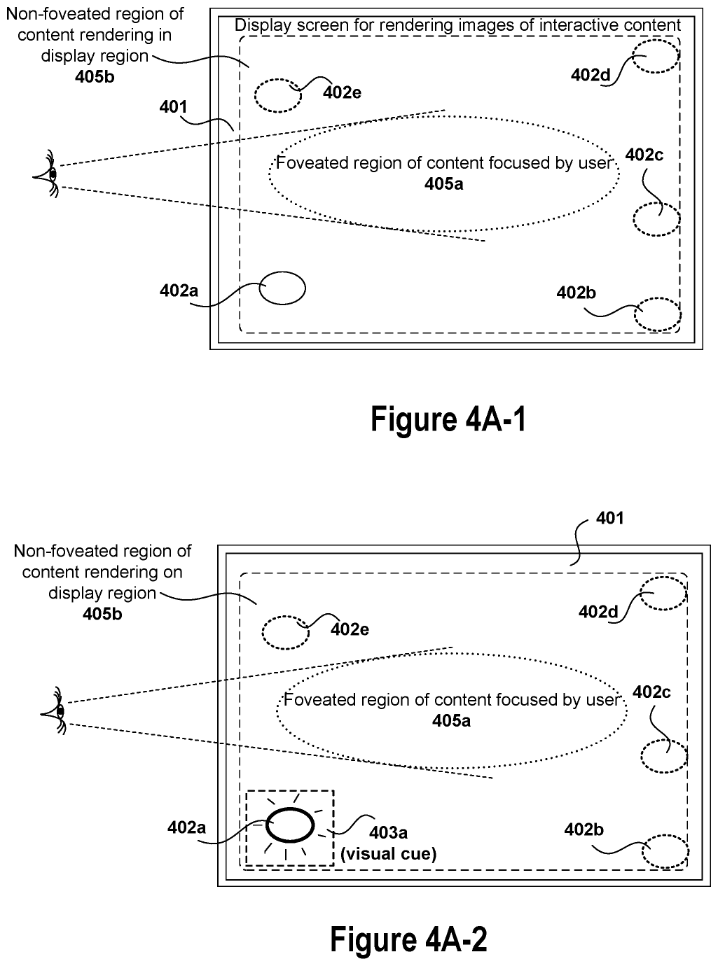

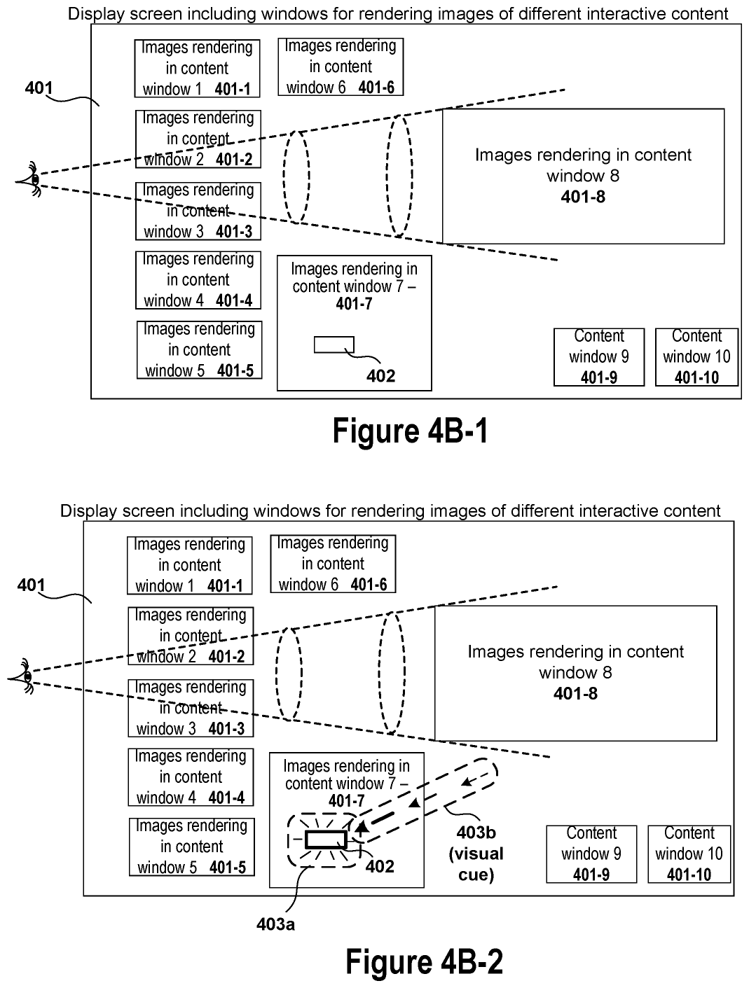

FIGS. 4A-1 and 4A-2 illustrate a display screen of a wearable device, such as the HMD 102, rendering content provided by an interactive application, such as the video game application, in one implementation. The content rendered at the display screen includes a first portion rendering in the foveated region 405a, wherein the first portion is the portion the user is focusing on, and a second portion rendering in the non-foveated region 405b, wherein the second portion is the portion that is outside of the foveated region. FIG. 4A-1 also shows a portion (i.e., region) 402a that is identified to include an event or action that is predicted to occur following the current game state of the video game, when the interactive application is a video game. The identified portion (i.e., region 402a) is provided as a mere example, and that other portions 402b-402e (shown with dotted lines) can be identified to follow the current game state.

The visual cue provisioning engine 126d uses the identification of the subsequent portion (e.g., region 402a identified by the content evaluation engine 126b) that is to be brought into focus following the content included in the foveated region 405a, and sends appropriate signal to the video game to emphasize the portion of the content included in the region 402a. Alternately, the signal can be generated to provide a visual cue at the portion of the content included in region 402a so as to suggest to the user to move their focus from the foveated region 405a to the region 402a where the action is predicted to occur. FIG. 4A-2 illustrates one such visual cue 403a provided in the region 402a, wherein the visual cue can be in the form of highlight or a blip. The visual cue is not restricted to the forms listed but can include other forms that are designed to catch the attention of the user.

FIGS. 4B-1 and 4B-2 illustrate a display screen of a wearable device, such as the HMD 102, rendering content from a plurality of interactive applications, in accordance with an alternate implementation. In this implementation, the content of the plurality of interactive applications are provided in distinct windows. FIG. 4B-1 illustrates a view of the display screen 401 includes a plurality of windows 401-1 through 401-10, with each window rendering content from a distinct application. As the size of the display screen 401 grows bigger and bigger, the amount of content rendered at the display screen correspondingly increase. The user's attention is shown to be focused on window 401-8 that is rendering content from an application (e.g., application 8—as shown by the cone representing the focus view of the user).

The content can be streaming content that changes in real-time. As the user is focusing on the content rendering in window 401-8, changes or actions/events can occur in another window that might require the user's attention or that the user needs to focus on. For example, in the example display screen illustrated in FIG. 4B-1, the user has to be looking at window 401-7 rendering content provided by an interactive application (e.g., application 7) where an event/action 402 is predicted to occur. Based on the predicted occurrence of an event/action 402 in window 401-7, the visual cue provisioning engine 126d provides a visual cue to direct the attention of the user from the content provided by application 8, for example, rendering in window 401-8 to the event/action 402 that is predicted to occur in the content provided by application 7 rendered in window 401-7. The visual cue can be in the form of highlighting the portion of the display screen where the event/action is predicted to occur in window 401-7, as shown in the visual cue box 403a or can be in the form of directional arrows (i.e., directional hint), as shown in the box 403b, or can be in the form of small light blip (not shown) that originates from the event/action 402, or in any other format that is capable of drawing the attention of the user.

Drawing the attention of the user to an event/action that is predicted to occur will assist the user to prepare for the event/action and not be taken by surprise when the event/action actually occurs. For example, in the case where the display screen is shown to provide content from a single application, the user may be focused on a first portion where the user is searching for an enemy while the enemy may be in a second portion and may be planning to attack the user from behind the user. Drawing the attention of the user to the second portion allows the user to focus on the second portion and to search for the enemy in and around the second portion so that the user can be prepared and ready to attack the enemy and not be taken by surprise by the enemy. Such assistance provided during game play allows the user to prepare for different scenarios and to advance in the game.

Collecting data related to the eye gestures of the user allows for multi-level tracking to capture multiple facets of the facial features of which eye gaze is one component. The cameras and sensors disposed in and around the wearable device (e.g., HMD 102) track movement of the eye lids, eye lashes, nose, mouth, skin, etc., and to use the tracked data to determine subtle signs of eye fatigue/eye strain experienced by the user, and to assist the user by adjusting the content so as to alleviate the user from the eye fatigue/eye strain. Additional assistance is provided in the form of visual cues to direct the user's attention in the right direction so that the user can progress in the game, for example. In some implementations, user selection of an option seeking assistance and a type/level of assistance can trigger the execution of the data collection and data processing engines at the client-device 102 and the eye gesture processing module at the server-computing device 106/or part of cloud 112 to provide the necessary assistance. Other advantages will become obvious to someone skilled in the art upon reading the various implementations.

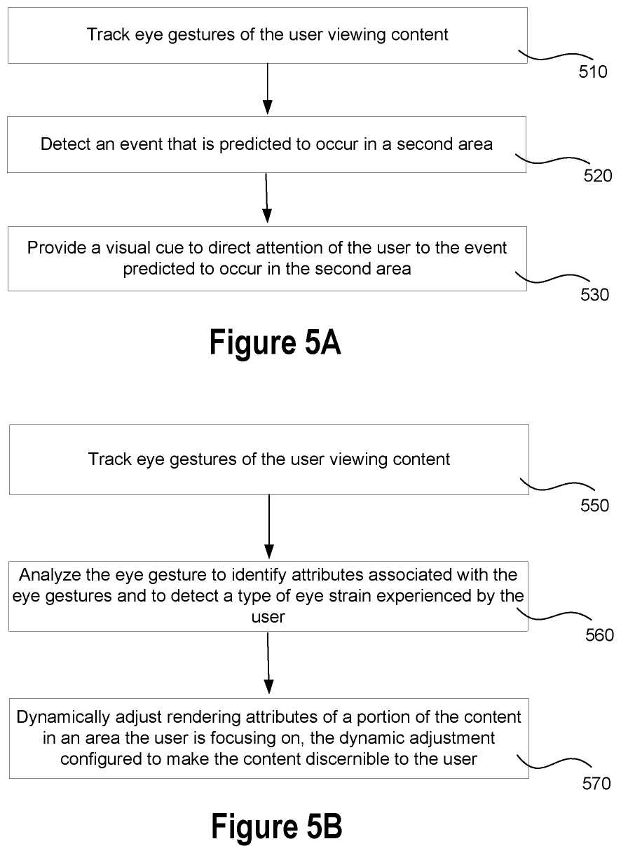

FIG. 5A illustrates flow of operations of a method used to provide assistance to a user during interaction with content of an interactive application rendered at a client device, in accordance with one implementation. The method begins at operation 510 wherein eye gestures of the user are tracked as the user is viewing content of an interactive application rendered at a client device. The eye gestures provide a multi-level tracking that can be used to identify subtle signs of eye strain or fatigue experienced by the user as the user is viewing the content. As the user is viewing the content in a first area (i.e., first portion), the system detects an event that is predicted to occur in a second area (i.e., second portion), as illustrated in operation 520. The event is predicted to occur based on the input of the user, a current state of the content rendered at the client device, and the content including type of content that is being rendered at the client device. In response to detecting an event that is predicted to occur in the second area, a visual cue is provided to the user to draw the attention of the user to the second area, as shown in operation 530. The eye gesture processing module directs the attention of the user to the second area to allow the user to prepare for the predicted event to occur so as to progress in the interactive application, such as the video game.

FIG. 5B illustrates flow of operations of a method used to provide assistance to a user during interaction with content of an interactive application rendered at a client device, in accordance with one implementation. The method begins at operation 550 wherein eye gestures of the user are tracked as the user is engaged in interacting with the content of an interactive application, such as a video game. The eye gestures track eye position, eye shape, eye gaze, facial gestures, head gestures, blink pattern, blink rate, eye movement, direction of movement, speed of movement, from which additional attributes, such as eye fatigue (determined from blink rate and/or eye shape), eye strain (including type and extent of eye strain-determined from eye shape when the user is squinting, for example), etc., are deduced. The eye gestures are analyzed to identify the associated attributes and use the attributes to determine if the user is experiencing eye strain and the type and level of eye strain, as illustrated in operation 560. The attributes of the eye gesture can be used to determine if the user is squinting and, if so, the length of squinting and the type of content that the user is viewing to determine that the user is having a hard time to decipher the content presented at the display screen associated with the client device. For example, when the content is a high density content or is being rendered at high speed, then the user will have to strain their eyes to absorb all the details included therein and to provide the appropriate input. In the case where the user is staring at a specific portion of the content for a long period of time, the eye gesture processing module may use the temporal (i.e., length of time) and other eye gesture attributes and the type of content that is being rendered to determine if the user is squinting and/or if the user is experiencing eye strain. If the user is experiencing eye strain or eye fatigue, then a type and level of eye strain experienced by the user is determined. Based on the type and level of eye strain experienced by the user, the eye gestures processing module generates appropriate signals to dynamically adjust the rendering attributes of a portion of the content that has caught the attention of the user, as illustrated in operation 570. An amount of dynamic adjustment to the content is determined to ensure that the adjustment renders the content in a manner that is discernible to the user. The adjustment to the content can be in the form of enhancing the resolution of the portion of the content, or magnifying the content rendering in the portion, adopting foveated rendering for the portion of the content, etc. The aforementioned adjustment to the content is provided as mere examples and other forms of adjustment that renders the content to be discernible to the user, can also be envisioned.

The visual cue and/or enhancing the rendering characteristics of the user are done by taking into consideration the visual characteristics of the user, wherein the visual characteristics are specific to the user. The visual cue and/or enhancing the rendering characteristics are done to draw the attention of the user to the content and to make the content discernible to the user. As noted above, the eye gesture processing module can be envisioned as a system-wide feature that can be built into the hardware so that the highlighting of the content or visual cue can be provided as overlays over the content that is rendering at the display screen. The eye gesture attributes can be provided as an API to a video game or other interactive application so that the application can use the eye gesture attributes to activate a game character or a voice-activated feature that directs the user toward some other direction than the direction that the user is focusing on. The capturing of the eye gesture data and processing of the eye gestures can be part of the operating system functionality of a game console or it could be performed by an eye-gesture processing module executing on the cloud server.

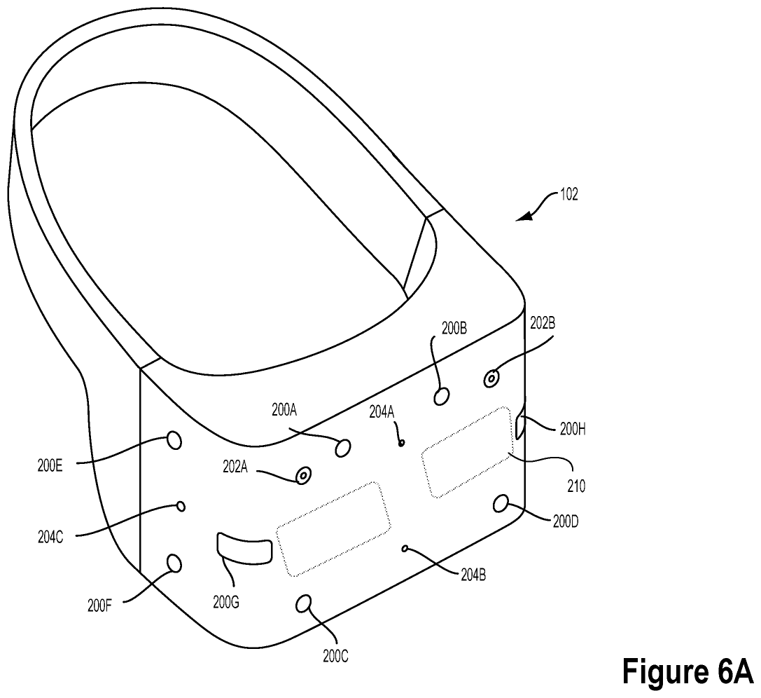

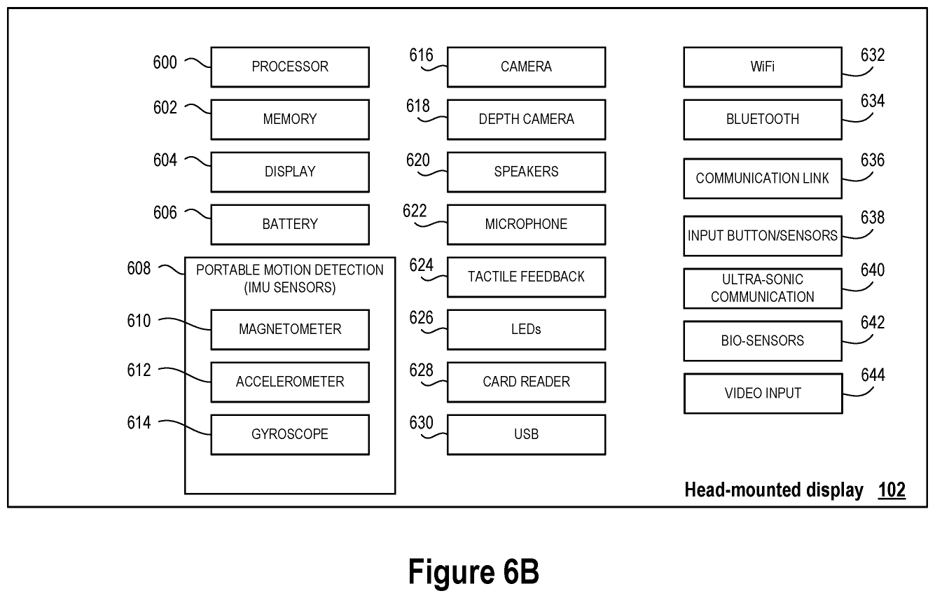

FIG. 6A illustrates an example implementation of a HMD 102 with a view of the external side of the HMD 102. The HMD 102 may or may not be configured to have see-through capability. As illustrated, the HMD 102 includes a pair of lens 210 (i.e., part of the optics), with each lens of the pair being oriented in front of each eye of the user, when the user is wearing the HMD 102. In an alternate implementation, the lens may be provided in front of one eye of the user, instead of both the eyes of the user. The HMD 102 illustrated in FIG. 6A is configured to render virtual reality environment. The HMD 102 can also be configured to render augmented reality environment, wherein the display screen is configured to have a see-through capability into the real-world in the vicinity of the user. In such implementations, the lens 210 is configured to allow the user to view the real-world objects as well as the virtual elements that are overlaid over some of the real-world objects. The pair of lens 210 may be configured to adjust the image of the virtual elements and the view of the real-world objects in accordance to vision characteristics of the user.

The HMD 102 includes a frame. The frame provides a housing for some of the components of the HMD 102, such as the Inertial Measure Unit (IMU) sensors, plurality of lights, microphones, image capturing devices that are used in the functioning of the HMD 102, memory and a processor that is communicatively connected to a computer 106. The HMD includes communication capabilities to access and interact with the computer 106. Additionally, the HMD 102 can be communicatively connected to the network 110 using wired, wireless, or 3G/4G/5G communication, etc. The HMD 102 may run an operating system and include network interfaces. In one implementation, the processor of the HMD 102 may also be communicatively connected to a controller (not shown), a glove interface object (104a of FIG. 1), one or more external cameras (not shown), a computer or stand-alone console (106 of FIG. 1), a router, to name a few. The glove interface object (104a of FIG. 1) is used to provide inputs to an interactive application providing content for the user to view. The external camera is used to capture images of the user wearing the HMD and forward it to the HMD or to the computer for processing. The HMD may process some of the data provided by the various components, including the sensors data, and forward the processed data to the computer 106 for further processing. The computer 106 may be used to process the data provided by the HMD 102 and provide updated content to the HMD for rendering to the user. Alternatively, the computer may forward the processed data provided by the HMD 102 to a cloud computing server for further processing. The data from the HMD 102 may be forwarded to the interactive application executing on the cloud computing server via a router and receive the content from the interactive application, which is then forwarded to the HMD 102 for rendering. Alternatively, the HMD 102 may forward the processed data directly to the interactive application executing on the cloud computing server (i.e., remote server) (part of cloud 112 of FIG. 1) via the router and, in return, receive content of the interactive application provided by the cloud computing server. When the HMD 102 directly communicates with the cloud computing device through the router, the HMD 102 will be a networked computing device.

The lights 200A-200H included in the HMD 102 are disposed on an outside surface of the frame of the HMD 102 and are used to track the HMD 102. The light 200A-200H may be configured to have specific shapes, and have the same or different colors. The lights 200A, 200B, 200C, and 200D are arranged on the outside surface on the front side of the HMD 102. The lights 200E and 200F are arranged on a side surface of the HMD 102 and the lights 200G and 200H are arranged at corners of the HMD 102. The lights 200A-200H are disposed to span the front surface and a side surface of the HMD 102. Images of the lights 200A-200H may be captured by an image capturing device (e.g., camera 108 of FIG. 1 or external camera(s)) and used to identify a location and an orientation of the HMD 102 in the physical environment where the user wearing the HMD 102 is present. It should be noted that some of the lights 200A-200H may or may not be visible depending upon the particular orientation of the HMD 102 relative to the image capture device. Also, different portions of lights (e.g. lights 200G and 200H) may be exposed for image capture depending upon the orientation of the HMD 102 relative to the image capture device.

In some implementations, the lights 200 can be configured to indicate a current status of the HMD to others in the vicinity. For example, some or all of the lights may be configured to have a certain color arrangement, intensity settings, be configured to blink, have a certain on/off configuration, or other arrangement indicating a current status of the HMD 102. By way of example, the lights can be configured to display different configurations during active gameplay of a video game (i.e., during an active timeline or during a time the user is navigating within a scene of the video game,) versus other non-active gameplay aspects of the video game (e.g., while configuring game settings of the video game or while navigating a menu or when paused), when the interactive application is a video game. The lights 200 might also be configured to indicate relative intensity levels of gameplay. For example, the intensity of lights, or a rate of blinking may be configured to increase when the intensity of gameplay increases. In this manner, a person external to the user may view the lights on the HMD 102 and understand that the user is actively engaged in intense gameplay and may not wish to be disturbed at that moment. In other example, the lights can be configured to display distinct configurations when interacting with other interactive applications. The lights 200 are therefore used to indicate to the person of whether the user is engaged in interaction with content rendering on the HMD 102, the user's level of engagement with the content, and to the system about the location of the HMD 102 in the physical environment where the user wearing the HMD 102 is present.

The HMD 102 may additionally include one or more microphones. In the illustrated embodiment, the HMD 102 includes microphones 204A and 204B defined on the front surface of the HMD 102, and microphone 204C defined on a side surface of the HMD 102. By utilizing an array of microphones, sound from each of the microphones can be processed to determine the location of the sound's source. This information can be utilized in various ways, including exclusion of unwanted sound sources, association of a sound source with a visual identification, triangulating the sound from the sound sources to pinpoint location and orientation of the HMD 102, etc. The microphones 204A-204C are used to capture the external sounds occurring in the physical environment in which the user wearing the HMD 102 is present.

The HMD 102 may also include one or more image capture devices in addition to the external image capture device (108 of FIG. 1). In the illustrated embodiment, the HMD 102 is shown to include image capture devices 202A and 202B disposed on the outside surface on the front face of the HMD 102. By utilizing a stereoscopic pair of image capture devices, three-dimensional (3D) images and video of the environment can be captured from the perspective of the HMD 102. Such video can be presented to the user to provide the user with a “video see-through” capability while wearing the HMD 102. In this implementation, the HMD 102 is not configured with a see-through capability. Even though the user cannot see through the HMD 102 in a strict sense, the video captured by the image capture devices 202A and 202B can nonetheless provide a functional equivalent of being able to see the environment external to the HMD 102 as if looking through the HMD 102. Such video can be augmented with virtual elements to provide an augmented reality experience. The augmentation may be done by overlaying the virtual elements over the objects in the video or may be combined or blended with the objects in the video in other ways. Though in the illustrated embodiment, two cameras are shown on the front surface of the HMD 102, it will be appreciated that there may be any number of externally facing cameras installed on the HMD 102, and oriented in different directions. For example, in another embodiment, there may be cameras mounted on the sides of the HMD 102 to provide additional panoramic image capture of the environment.

In another implementation, the HMD 102 may provide a see-through capability with the display screen of the HMD 102 being transparent for the user to view the physical environment of the real-world in the vicinity of the user. In this implementation, images of the virtual elements may be super-imposed over portions of the real-world objects. The HMD 102, in this alternate implementation is configured for augmented reality applications.

FIG. 6B illustrates various components of a head mounted display 102, in accordance with one implementation of the disclosure. The head mounted display 102 includes a processor 600 for executing program instructions. A memory 602 is provided for storage purposes, and may include both volatile and non-volatile memory. A display 604 is included which provides a visual interface that a user may use to view content. A battery 606 is provided as a power source for the head mounted display 102. A motion detection module 608 may include any of various kinds of motion sensitive hardware, such as a magnetometer 610, an accelerometer 612, and a gyroscope 614.

An accelerometer 612 is a device for measuring acceleration and gravity induced reaction forces. Single and multiple axis models are available to detect magnitude and direction of the acceleration in different directions. The accelerometer is used to sense inclination, vibration, and shock. In one embodiment, three accelerometers 612 are used to provide the direction of gravity, which gives an absolute reference for two angles (world-space pitch and world-space roll).

A magnetometer 610 measures the strength and direction of the magnetic field in the vicinity of the head mounted display. In one embodiment, three magnetometers 610 are used within the head mounted display, ensuring an absolute reference for the world-space yaw angle. In one embodiment, the magnetometer is designed to span the earth magnetic field, which is ±80 microtesla. Magnetometers are affected by metal, and provide a yaw measurement that is monotonic with actual yaw. The magnetic field may be warped due to metal in the environment, which causes a warp in the yaw measurement. If necessary, this warp can be calibrated using information from other sensors such as the gyroscope or the camera. In one embodiment, accelerometer 612 is used together with magnetometer 610 to obtain the inclination and azimuth of the head mounted display 102.

In some implementations, the magnetometers 610 of the head mounted display 102 are configured so as to be read during times when electromagnets in other nearby devices are inactive.

A gyroscope 614 is a device for measuring or maintaining orientation, based on the principles of angular momentum. In one embodiment, three gyroscopes 614 provide information about movement across the respective axis (x, y and z) based on inertial sensing. The gyroscopes help in detecting fast rotations. However, the gyroscopes can drift overtime without the existence of an absolute reference. This requires resetting the gyroscopes periodically, which can be done using other available information, such as positional/orientation determination based on visual tracking of an object, accelerometer, magnetometer, etc.

A camera 616 is provided for capturing images and image streams of a real environment. More than one camera may be included in the head mounted display 102, including a camera that is rear-facing (directed away from a user when the user is viewing the display of the head mounted display 102), and a camera that is front-facing (directed towards the user when the user is viewing the display of the head mounted display 102). Additionally, a depth camera 618 may be included in the head mounted display 102 for sensing depth information of objects in a real environment.

The head mounted display 102 includes speakers 620 for providing audio output. Also, a microphone 622 may be included for capturing audio from the real environment, including sounds from the ambient environment, speech made by the user, etc. The head mounted display 102 includes tactile feedback module 624 for providing tactile feedback to the user. In one embodiment, the tactile feedback module 624 is capable of causing movement and/or vibration of the head mounted display 102 so as to provide tactile feedback to the user. LEDs 626 are provided as visual indicators of statuses of the head mounted display 102. For example, an LED may indicate battery level, power on, etc. A card reader 628 is provided to enable the head mounted display 102 to read and write information to and from a memory card. A USB interface 630 is included as one example of an interface for enabling connection of peripheral devices, or connection to other devices, such as other portable devices, computers, etc. In various embodiments of the head mounted display 102, any of various kinds of interfaces may be included to enable greater connectivity of the head mounted display 102.

A WiFi module 632 is included for enabling connection to the Internet or a local area network via wireless networking technologies. Also, the head mounted display 102 includes a Bluetooth module 634 for enabling wireless connection to other devices. A communications link 636 may also be included for connection to other devices. In one embodiment, the communications link 636 utilizes infrared transmission for wireless communication. In other embodiments, the communications link 636 may utilize any of various wireless or wired transmission protocols for communication with other devices.

Input buttons/sensors 638 are included to provide an input interface for the user. Any of various kinds of input interfaces may be included, such as buttons, touchpad, joystick, trackball, etc. An ultra-sonic communication module 640 may be included in head mounted display 102 for facilitating communication with other devices via ultra-sonic technologies. Bio-sensors 642 are included to enable detection of physiological data from a user. In one embodiment, the bio-sensors 642 include one or more dry electrodes for detecting bio-electric signals of the user through the user's skin. A video input 644 is configured to receive a video signal from a primary processing computer (e.g. main game console) for rendering on the HMD. In some implementations, the video input is an HDMI input.

The foregoing components of head mounted display 102 have been described as merely exemplary components that may be included in head mounted display 102. In various embodiments of the disclosure, the head mounted display 102 may or may not include some of the various aforementioned components. Embodiments of the head mounted display 102 may additionally include other components not presently described, but known in the art, for purposes of facilitating aspects of the present disclosure as herein described.

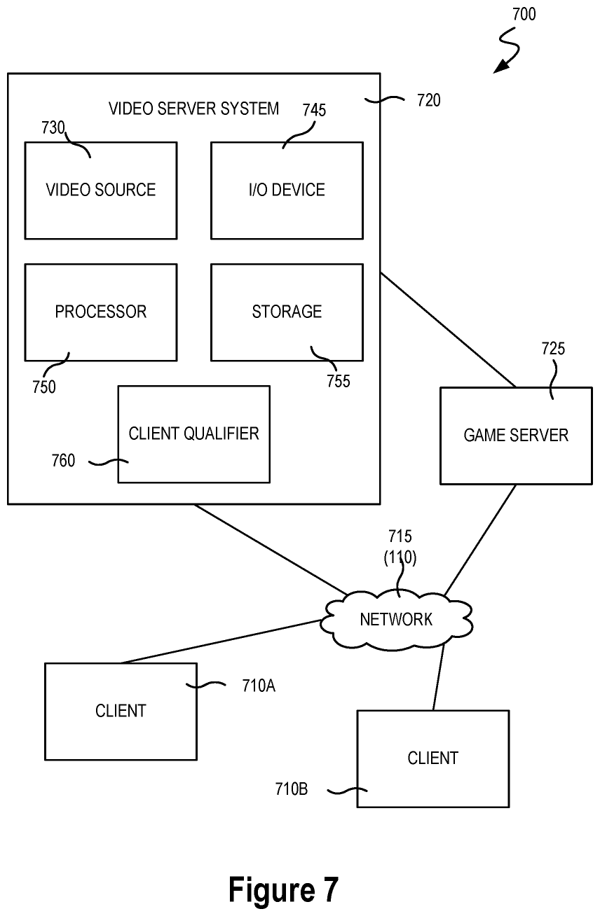

FIG. 7 is a block diagram of an example Game System 700 that may be used to provide content to the HMD for user consumption and interaction, according to various embodiments of the disclosure. Game System 700 is configured to provide a video stream to one or more Clients 710 via a Network 715, wherein one or more of the clients 710 may include HMD (102), eyeglasses, or other wearable devices. In one implementation, the Game System 700 is shown to be a cloud game system with an instance of the game being executed on a cloud server and the content streamed to the clients 710. In an alternate implementation, the Game System 700 may include a game console that executes an instance of the game and provides streaming content to the HMD for rendering. Game System 700 typically includes a Video Server System 720 and an optional game server 725. Video Server System 720 is configured to provide the video stream to the one or more Clients 710 with a minimal quality of service. For example, Video Server System 720 may receive a game command that changes the state of or a point of view within a video game, and provide Clients 710 with an updated video stream reflecting this change in state with minimal lag time. The Video Server System 720 may be configured to provide the video stream in a wide variety of alternative video formats, including formats yet to be defined. Further, the video stream may include video frames configured for presentation to a user at a wide variety of frame rates. Typical frame rates are 30 frames per second, 60 frames per second, and 120 frames per second. Although higher or lower frame rates are included in alternative embodiments of the disclosure.

Clients 710, referred to herein individually as 710A, 710B, etc., may include head mounted displays, terminals, personal computers, game consoles, tablet computers, telephones, set top boxes, kiosks, wireless devices, digital pads, stand-alone devices, handheld game playing devices, and/or the like. Typically, Clients 710 are configured to receive encoded video streams, decode the video streams, and present the resulting video to a user, e.g., a player of a game. The processes of receiving encoded video streams and/or decoding the video streams typically includes storing individual video frames in a receive buffer of the Client. The video streams may be presented to the user on a display integral to Client 710 or on a separate device such as a monitor or television. Clients 710 are optionally configured to support more than one game player. For example, a game console may be configured to support two, three, four or more simultaneous players. Each of these players may receive a separate video stream, or a single video stream may include regions of a frame generated specifically for each player, e.g., generated based on each player's point of view. Clients 710 are optionally geographically dispersed. The number of clients included in Game System 700 may vary widely from one or two to thousands, tens of thousands, or more. As used herein, the term “game player” is used to refer to a person that plays a game and the term “game playing device” is used to refer to a device used to play a game. In some embodiments, the game playing device may refer to a plurality of computing devices that cooperate to deliver a game experience to the user. For example, a game console and an HMD may cooperate with the video server system 720 to deliver a game viewed through the HMD. In one embodiment, the game console receives the video stream from the video server system 720, and the game console forwards the video stream, or updates to the video stream, to the HMD for rendering.

Clients 710 are configured to receive video streams via Network 715. Network 715 may be any type of communication network including, a telephone network, the Internet, wireless networks, powerline networks, local area networks, wide area networks, private networks, and/or the like. In typical embodiments, the video streams are communicated via standard protocols, such as TCP/IP or UDP/IP. Alternatively, the video streams are communicated via proprietary standards.

A typical example of Clients 710 is a personal computer comprising a processor, non-volatile memory, a display, decoding logic, network communication capabilities, and input devices. The decoding logic may include hardware, firmware, and/or software stored on a computer readable medium. Systems for decoding (and encoding) video streams are well known in the art and vary depending on the particular encoding scheme used.

Clients 710 may, but are not required to, further include systems configured for modifying received video. For example, a Client may be configured to perform further rendering, to overlay one video image on another video image, to crop a video image, and/or the like. For example, Clients 710 may be configured to receive various types of video frames, such as I-frames, P-frames and B-frames, and to process these frames into images for display to a user. In some embodiments, a member of Clients 710 is configured to perform further rendering, shading, conversion to 3-D, or like operations on the video stream. A member of Clients 710 is optionally configured to receive more than one audio or video stream. Input devices of Clients 710 may include, for example, a one-hand game controller, a two-hand game controller, a gesture recognition system, a gaze recognition system, a voice recognition system, a keyboard, a joystick, a pointing device, a force feedback device, a motion and/or location sensing device, a mouse, a touch screen, a neural interface, a camera, input devices yet to be developed, and/or the like.

The video stream (and optionally audio stream) received by Clients 710 is generated and provided by Video Server System 720. As is described further elsewhere herein, this video stream includes video frames (and the audio stream includes audio frames). The video frames are configured (e.g., they include pixel information in an appropriate data structure) to contribute meaningfully to the images displayed to the user. As used herein, the term “video frames” is used to refer to frames including predominantly information that is configured to contribute to, e.g. to effect, the images shown to the user. Most of the teachings herein with regard to “video frames” can also be applied to “audio frames.”

Clients 710 are typically configured to receive inputs from a user. These inputs may include game commands configured to change the state of the video game or otherwise affect game play. The game commands can be received using input devices and/or may be automatically generated by computing instructions executing on Clients 710. The received game commands are communicated from Clients 710 via Network 715 to Video Server System 720 and/or Game Server 725. For example, in some embodiments, the game commands are communicated to Game Server 725 via Video Server System 720. In some embodiments, separate copies of the game commands are communicated from Clients 710 to Game Server 725 and Video Server System 720. The communication of game commands is optionally dependent on the identity of the command. Game commands are optionally communicated from Client 710A through a different route or communication channel that that used to provide audio or video streams to Client 710A.

Game Server 725 is optionally operated by a different entity than Video Server System 720. For example, Game Server 725 may be operated by the publisher of a multiplayer game. In this example, Video Server System 720 is optionally viewed as a client by Game Server 725 and optionally configured to appear from the point of view of Game Server 725 to be a prior art client executing a prior art game engine. Communication between Video Server System 720 and Game Server 725 optionally occurs via Network 715. As such, Game Server 725 can be a prior art multiplayer game server that sends game state information to multiple clients, one of which is game server system 720. Video Server System 720 may be configured to communicate with multiple instances of Game Server 725 at the same time. For example, Video Server System 720 can be configured to provide a plurality of different video games to different users. Each of these different video games may be supported by a different Game Server 725 and/or published by different entities. In some embodiments, several geographically distributed instances of Video Server System 720 are configured to provide game video to a plurality of different users. Each of these instances of Video Server System 720 may be in communication with the same instance of Game Server 725. Communication between Video Server System 720 and one or more Game Server 725 optionally occurs via a dedicated communication channel. For example, Video Server System 720 may be connected to Game Server 725 via a high bandwidth channel that is dedicated to communication between these two systems.

Video Server System 720 comprises at least a Video Source 730, an I/O Device 745, a Processor 750, and non-transitory Storage 755. Video Server System 720 may include one computing device or be distributed among a plurality of computing devices. These computing devices are optionally connected via a communications system such as a local area network.

Video Source 730 is configured to provide a video stream, e.g., streaming video or a series of video frames that form a moving picture. In some embodiments, Video Source 730 includes a video game engine and rendering logic. The video game engine is configured to receive game commands from a player and to maintain a copy of the state of the video game based on the received commands. This game state includes the position of objects in a game environment, as well as typically a point of view. The game state may also include properties, images, colors and/or textures of objects. The game state is typically maintained based on game rules, as well as game commands such as move, turn, attack, set focus to, interact, use, and/or the like. Part of the game engine is optionally disposed within Game Server 725. Game Server 725 may maintain a copy of the state of the game based on game commands received from multiple players using geographically disperse clients. In these cases, the game state is provided by Game Server 725 to Video Source 730, wherein a copy of the game state is stored and rendering is performed. Game Server 725 may receive game commands directly from Clients 710 via Network 715, and/or may receive game commands via Video Server System 720.

Video Source 730 typically includes rendering logic, e.g., hardware, firmware, and/or software stored on a computer readable medium such as Storage 755. This rendering logic is configured to create video frames of the video stream based on the game state. All or part of the rendering logic is optionally disposed within a graphics processing unit (GPU). Rendering logic typically includes processing stages configured for determining the three-dimensional spatial relationships between objects and/or for applying appropriate textures, etc., based on the game state and viewpoint. The rendering logic produces raw video that is then usually encoded prior to communication to Clients 710. For example, the raw video may be encoded according to an Adobe Flash® standard,.wav, H.264, H.263, On2, VP6, VC-1, WMA, Huffyuv, Lagarith, MPG-x. Xvid. FFmpeg, x264, VP6-8, realvideo, mp3, or the like. The encoding process produces a video stream that is optionally packaged for delivery to a decoder on a remote device. The video stream is characterized by a frame size and a frame rate. Typical frame sizes include 800×600, 1280×720 (e.g., 720 p), 1024×768, although any other frame sizes may be used. The frame rate is the number of video frames per second. A video stream may include different types of video frames. For example, the H.264 standard includes a “P” frame and a “I” frame. I-frames include information to refresh all macro blocks/pixels on a display device, while P-frames include information to refresh a subset thereof. P-frames are typically smaller in data size than are I-frames. As used herein the term “frame size” is meant to refer to a number of pixels within a frame. The term “frame data size” is used to refer to a number of bytes required to store the frame.

In alternative embodiments Video Source 730 includes a video recording device such as a camera. This camera may be used to generate delayed or live video that can be included in the video stream of a computer game. The resulting video stream, optionally includes both rendered images and images recorded using a still or video camera. Video Source 730 may also include storage devices configured to store previously recorded video to be included in a video stream. Video Source 730 may also include motion or positioning sensing devices configured to detect motion or position of an object, e.g., person, and logic configured to determine a game state or produce video-based on the detected motion and/or position.

Video Source 730 is optionally configured to provide overlays configured to be placed on other video. For example, these overlays may include a command interface, log in instructions, messages to a game player, images of other game players, video feeds of other game players (e.g., webcam video). In embodiments of Client 710A including a touch screen interface or a gaze detection interface, the overlay may include a virtual keyboard, joystick, touch pad, and/or the like. In one example of an overlay a player's voice is overlaid on an audio stream. Video Source 730 optionally further includes one or more audio sources.

In embodiments wherein Video Server System 720 is configured to maintain the game state based on input from more than one player, each player may have a different point of view comprising a position and direction of view. Video Source 730 is optionally configured to provide a separate video stream for each player based on their point of view. Further, Video Source 730 may be configured to provide a different frame size, frame data size, and/or encoding to each of Client 710. Video Source 730 is optionally configured to provide 3-D video.

I/O Device 745 is configured for Video Server System 720 to send and/or receive information such as video, commands, requests for information, a game state, gaze information, device motion, device location, user motion, client identities, player identities, game commands, security information, audio, and/or the like. I/O Device 745 typically includes communication hardware such as a network card or modem. I/O Device 745 is configured to communicate with Game Server 725, Network 715, and/or Clients 710.

Processor 750 is configured to execute logic, e.g. software, included within the various components of Video Server System 720 discussed herein. For example, Processor 750 may be programmed with software instructions in order to perform the functions of Video Source 730, Game Server 725, and/or a Client Qualifier 760. Video Server System 720 optionally includes more than one instance of Processor 750. Processor 750 may also be programmed with software instructions in order to execute commands received by Video Server System 720, or to coordinate the operation of the various elements of Game System 700 discussed herein. Processor 750 may include one or more hardware device. Processor 750 is an electronic processor.

Storage 755 includes non-transitory analog and/or digital storage devices. For example, Storage 755 may include an analog storage device configured to store video frames. Storage 755 may include a computer readable digital storage, e.g. a hard drive, an optical drive, or solid state storage. Storage 755 is configured (e.g. by way of an appropriate data structure or file system) to store video frames, artificial frames, a video stream including both video frames and artificial frames, audio frame, an audio stream, and/or the like. Storage 755 is optionally distributed among a plurality of devices. In some embodiments, Storage 755 is configured to store the software components of Video Source 730 discussed elsewhere herein. These components may be stored in a format ready to be provisioned when needed.

Video Server System 720 optionally further comprises Client Qualifier 760. Client Qualifier 760 is configured for remotely determining the capabilities of a client, such as Clients 710A or 710B. These capabilities can include both the capabilities of Client 710A itself as well as the capabilities of one or more communication channels between Client 710A and Video Server System 720. For example, Client Qualifier 760 may be configured to test a communication channel through Network 715.

Client Qualifier 760 can determine (e.g., discover) the capabilities of Client 710A manually or automatically. Manual determination includes communicating with a user of Client 710A and asking the user to provide capabilities. For example, in some embodiments, Client Qualifier 760 is configured to display images, text, and/or the like within a browser of Client 710A. In one embodiment, Client 710A is an HMD that includes a browser. In another embodiment, client 710A is a game console having a browser, which may be displayed on the HMD. The displayed objects request that the user enter information such as operating system, processor, video decoder type, type of network connection, display resolution, etc. of Client 710A. The information entered by the user is communicated back to Client Qualifier 760.

Automatic determination may occur, for example, by execution of an agent on Client 710A and/or by sending test video to Client 710A. The agent may comprise computing instructions, such as java script, embedded in a web page or installed as an add-on. The agent is optionally provided by Client Qualifier 760. In various embodiments, the agent can find out processing power of Client 710A, decoding and display capabilities of Client 710A, lag time reliability and bandwidth of communication channels between Client 710A and Video Server System 720, a display type of Client 710A, firewalls present on Client 710A, hardware of Client 710A, software executing on Client 710A, registry entries within Client 710A, and/or the like.

Client Qualifier 760 includes hardware, firmware, and/or software stored on a computer readable medium. Client Qualifier 760 is optionally disposed on a computing device separate from one or more other elements of Video Server System 720. For example, in some embodiments, Client Qualifier 760 is configured to determine the characteristics of communication channels between Clients 710 and more than one instance of Video Server System 720. In these embodiments the information discovered by Client Qualifier can be used to determine which instance of Video Server System 720 is best suited for delivery of streaming video to one of Clients 710.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for providing assistance to a user viewing content, comprising:
tracking eye gestures of the user viewing the content to identify attributes associated with the eye gestures, the attributes used to determine a specific area of the content that the user is focusing on;
detecting an event that is predicted to occur in a second area of the content that requires attention of the user, wherein the second area is different from the specific area that the user is focusing on; and
providing a visual cue to draw the attention of the user to the second area where the event is predicted to occur within the content being viewed by the user,
wherein operations of the method are performed by an eye gesture processing module executing on a processor of a computing device.

2. The method of claim 1, wherein tracking the eye gestures further includes,
capturing facial features of the user as the user is interacting with the content, the facial features captured using a plurality of sensors and one or more image capturing devices available within a physical environment where the user is interacting with the content; and
classifying the facial features to define metadata, the metadata used to generate and train an artificial intelligence (AI) model, output from the AI model used to define attributes associated with the eye gestures to dynamically adjust content being presented to the user and to provide the visual cue for the event predicted to occur.

3. The method of claim 1, wherein the visual cue is a foveated visual cue provided at the second area where the event is predicted to occur.

4. The method of claim 1, wherein the visual cue is provided as a directional hint directing the attention of the user toward the second area of the content that corresponds with the event that is predicted to occur.

5. The method of claim 1, further includes,
analyzing the attributes associated with the eye gestures to determine a type of eye strain experienced by the user as the user is focused on the specific area of the content; and
when the type of eye strain experienced by the user corresponds with difficulty in viewing content rendering in the specific area, responsively adjusting a portion of the content that corresponds with the specific area focused by the user to make the content in the specific area viewable by the user.

6. The method of claim 5, wherein adjusting the portion includes dynamically magnifying or reducing a size of the portion of the content rendered in the specific area so as to make the portion of the content viewable by the user, wherein an amount of magnifying or reducing is defined to be specific for the user and is determined based on vision characteristics of the user.

7. The method of claim 1, wherein tracking the eye gestures further includes,
forwarding the attributes identified for the eye gestures through an application programming interface (API) to an interactive application providing the content, the interactive application processing the attributes of the eye gestures to identify a level of eye strain experienced by the user, and
responsively directing the attention of the user to the second area that is different from the specific area that the user is focusing on, the content in the second area being presented using foveated visual rendering.

8. The method of claim 7, wherein the interactive application is a video game and the content is game content.

9. The method of claim 1, wherein when the content includes text content, providing the visual cue includes dynamically auto-tuning a magnification level of the text content based on vision characteristics of the user, wherein the auto-tuning of the magnification level includes magnifying or reducing a size of the text content.

10. The method of claim 1, wherein the computing device is a game console and the content is game content, and wherein the eye gesture processing module is part of an operating system of the game console.

11. The method of claim 1, wherein the computing device is a cloud server of a cloud system and the eye gesture processing module is executed by the processor of the computing device in the cloud system.

12. The method of claim 1, wherein the eye gesture processing module is incorporated into hardware of the computing device, the eye gesture processing module configured to provide the visual cue as an overlay over the second area of the content rendering at a display screen.

13. A method for providing assistance to a user viewing content, comprising:
tracking eye gestures of the user viewing the content, the eye gestures analyzed to identify attributes associated with the eye gestures, the attributes used to determine an area within the content that the user is focusing on;
analyzing the attributes associated with the eye gestures of the user to detect the user experiencing a type of eye strain that causes the user unable to discern the content; and
dynamically adjusting rendering attributes of a portion of the content presented in the area that the user is focusing on so as to make the content discernible to the user, a level of adjusting of the rendering attributes defined based on vision characteristics of the user viewing the content,
wherein operations of the method are performed by an eye gesture processing module executing on a processor of a computing device.

14. The method of claim 13, wherein analyzing the attributes further includes, engaging a machine learning algorithm to,
analyze the attributes associated with the eye gestures;
classify the attributes, the classifying used to tag the attributes with metadata;
generate an artificial intelligence (AI) model, the AI model trained using the metadata associated with the eye gestures; and
identify an output from the AI model that identifies a type of eye strain that correspond with the attributes of the eye gestures.

15. The method of claim 13, wherein dynamically adjusting rendering attributes includes magnifying or reducing a size of the content rendering in the portion of the content, a level of magnification or reduction defined based on visual characteristics of the user.

16. The method of claim 13, wherein the dynamically adjusting includes providing a text content overlay, when the content includes text content.
